(19) United States
(12) Patent Application Publication
(10) Pub. No.: US 2022/0091570 A1
(43) Pub. Date: Mar. 24, 2022

(54) DEVICE AND METHOD FOR REDUCTION OR CESSATION OF INHALATION OF COMPOUNDS

(71) Applicant: KTH Technologies Corporation, Claymont, DE (US)

(72) Inventors: Christopher Lemuel, Montclair, NJ (US); John P. Rudio, New York, NY (US)

(21) Appl. No.: 17/472,178

(22) Filed: Sep. 10, 2021

Related U.S. Application Data
(60) Provisional application No. 63/080,505, filed on Sep. 18, 2020.

(51) Int. Cl. G05B 19/042

(52) U.S. Cl. CPC G05B 19/042; G05B 2219/2614

(57) ABSTRACT

Disclosed is a controlled delivery system for a vaporizable compound, wherein the system includes an electronic vaporizing apparatus configured to execute algorithms that provide a user with real-time estimates of an amount of the vaporizable compound delivered during use of the apparatus. The system further includes algorithms that allow the user to program, track, and manage the total compound delivered on a scheduled basis, such as daily, in an effort toward cessation of compound consumption over a predetermined time period.

### CROSS REFERENCE TO RELATED APPLICATIONS

The present application claims the benefit of U.S. Provisional Application 63/080,505 filed 18 Sep. 2020; which is incorporated herein by reference in its entirety.

### TECHNICAL FIELD

This disclosure generally relates to a system and methods for the progressive, programed reduction of a vaporized compound intake while using an electronic vaporizing apparatus.

### BACKGROUND

Cigarette smoking is known to be causative of a wide range of diseases linked to the inhalation of pesticides, carbon monoxide, nicotine and tars. In addition to lung diseases, smoking can cause poor vision, premature aging, and increases the likelihood of stroke, diabetes, cardiovascular disease, osteoporosis, infertility, and more. There exists a long history of research and effort invested in helping people find the best way to quit smoking cigarettes. One long used and generally ineffective approach to smoking cessation is the “cold turkey” method, where the smoker abruptly ceases smoking at a given time. While a majority of former smokers report having tried to quit smoking using the cold turkey method, only about 5% are successful after 6 months (Hughes, et al. 2004 “Shape of the relapse curve and long-term abstinence among untreated smokers” Addiction 99:29-38).

Gradual smoking cessation methods generally include use of a nicotine delivery alternative. For example, the nicotine patch serves as a transdermal nicotine delivery system that provides nicotine to a person under the theory that smoking can be reduced or eliminated if the addictive component of the cigarette is provided to the bloodstream through a mechanism other than inhaling the nicotine-bearing smoke. Other approaches include nicotine gum, nicotine inhalers, and/or sublingual nicotine tablets; again, mechanisms of nicotine delivery other than through smoking. Despite the availability of these smoking cessation aids, the success rate among motivated smokers to quit smoking is very low, generally 10% or less after 12 months (Black, J. 2010 “Evidence base and strategies for successful smoking cessation” J. Vasc. Surgery 51:1529-1537).

Addiction to smoking is a combination of both biological and behavioral habits. Each of the aforementioned methods for smoking cessation ignore the behavioral habit of smoking. Computer-assisted smoking cessation scheduling protocols, such as on a smoker's mobile electronic device or computer, have been used to facilitate delivery of timed alerts over ever-increasing intervals. Some of these programs require smokers to manually register each smoking event and provide a systematic pacer to reduce smoking sessions and nicotine consumption. Presumably, as nicotine fades, the smoker adjusts to longer spans between cigarettes and practices coping skills to better tolerate withdrawal. These methods assume a direct link between the chemical and behavioral addictions and are thus prone to noncompliance by the smoker and ultimate failure.

The recent introduction of electronic vaporizing apparatuses or e-cigarettes provide an alternative to cigarette smoking. While the compounds used in these devices are a healthier alternative to cigarette smoking, typically delivering compounds free from pesticides and tars, they frequently still deliver large doses of nicotine or other vaporizable compounds.

### SUMMARY

Therefore, a need exists for systems and methods for controlled delivery of a vaporizable compound according to a user selected cessation protocol, wherein the user may monitor compound intake in real time and may select and modify the cessation protocol accordingly.

The present disclosure provides a controlled delivery system for a vaporizable compound. The system includes an electronic vaporizing apparatus configured to execute algorithms that provide a user with real-time estimates of an amount of the vaporizable compound delivered during use of the apparatus. The system further includes algorithms that allow the user to schedule, track, and manage the total compound delivered on a programmed basis, such as daily, in an effort toward cessation of compound consumption over a predetermined time period. For example, a smoker may use the system for nicotine cessation, reducing nicotine consumption over the course of several weeks or months. The use may further use the device for smoking or vaping cessation, reducing use of the device over the course of several weeks or months.

Accordingly, the present disclosure relates to a device comprising a processor, a heating element coupled to the processor, an air flow sensor coupled to the processor, an energy sensor coupled to the processor and the heating element, and a temperature sensor coupled to the processor and the heating element. The processor includes instructions that determine a flow rate of air across the heating element based on a signal from the air flow sensor, determine an amount of energy delivered to the heating element based on a signal from the energy sensor, determine a temperature of the heating element based on a signal received from the temperature sensor, determine a baseline value for the device, determine a dose of the compound during a predetermined period of time based on the flow rate, the amount of energy, the temperature, and the baseline value, and set a parameter of the device to provide the determined dose.

According to certain aspects, the air flow sensor may be configured to determine inspiratory flow.

According to certain aspects, the device may further comprise an airway and a mouthpiece, wherein the airway is near the mouthpiece, and wherein the flow rate of air across the heating element is determined based on a differential between an atmospheric pressure and a pressure at the airway.

According to certain aspects, the energy sensor may be configured to determine the amount of energy delivered to the heating element.

According to certain aspects, the energy sensor may comprise a voltage meter.

According to certain aspects, the amount of energy may be determined by multiplying a measured voltage across a resistor at the heating element by a determined current at the heating element.

According to certain aspects, the temperature sensor may be configured to sense the temperature of the heating element.

According to certain aspects, the temperature of the heating element may be determined by measuring the voltage and current applied to the heating element and based on a heating element material.

According to certain aspects, the baseline value may be determined based on an amount of a compound used during a predetermined period of time at a predetermined air flow rate, a predetermined compound concentration, and a predetermined heating element power.

According to certain aspects, the dose of the compound may be determined based on the determined flow rate, the predetermined compound concentration, the determined heating element power, the baseline value, and a time period during which the device is used.

According to certain aspects, the dose may be determined based on a plurality of determinations over the predetermined period of time.

According to certain aspects, the determinations may be made at a rate exceeding 5 cycles per second, such as at least 10 cycles per second.

According to certain aspects, the baseline value may be determined based on at least one of a user trial, user utilization, or testing.

According to certain aspects, at least one of the dose or the parameter may be determined based on a biometric feedback of the user, or in real time, or at least one of prior to or after each inhalation from the device, and/or may be adjusted continually.

According to certain aspects, the presently disclosed system may further determine a weaning schedule based on at least one of the dose of the compound during the predetermined period of time or the parameter, wherein the weaning schedule may be static or dynamic, and/or may be updated in real time.

According to certain aspects, the presently disclosed system may further determine a deviation from the weaning schedule based on at least one of the dose of the compound during the predetermined period of time or the parameter, or based on the deviation. In this latter case, the parameter may be adjusted based on the deviation.

It is to be understood that both the foregoing general description and the following detailed description are exemplary and are not restrictive of the embodiments of the present disclosure as claimed.

### BRIEF DESCRIPTION OF THE DRAWINGS

All of the figures depict preferred embodiments although other embodiments are contemplated, and the present disclosure is not limited to the embodiments shown.

FIG. 1A is a diagrammatical overview of a controlled compound delivery system according to aspects of the present disclosure.

FIG. 1B is a diagrammatical overview of the data transfer scheme capability for the controlled compound delivery system, using the apparatus, algorithms, software, and associated applications and hardware according to aspects of the present disclosure.

FIGS. 2A-2C provide flow charts depicting a compound use limit algorithm, such as for the compound nicotine, according to aspects of the present disclosure.

FIGS. 3A-3B provide flow charts depicting a compound estimation algorithm, such as for the compound nicotine, according to aspects of the present disclosure.

FIG. 4A is a cross-sectional view of components of an electronic vaporizing apparatus for controlled compound delivery according to aspects of the present disclosure.

FIG. 4B is an exploded view of components of the electronic vaporizing apparatus shown in FIG. 4A.

### DETAILED DESCRIPTION

The present disclosure provides an electronic vaporizing device and associated algorithms that enforce limits on the intake of a vaporizable compound from the device. For example, when the device is used with a nicotine containing liquid, the presently disclosed system may regulate the nicotine intake in real time based on certain user defined parameters and/or driven by biometric information collected via common wearable health monitors and/or supplied by the user.

According to certain aspects, the device may communicate, i.e. “sync”, over a local area network, such as, for example, Bluetooth or Bluetooth Low Energy with a software application, i.e., “app”, running on a mobile device, laptop, tablet, or desktop computer, or some other microprocessor based device. The app serves as the user interface for defining certain limits, viewing data collected from the device, reviewing basic status information about the device, and to interact with a support community of users who are also using the app (e.g., users who are trying to reduce nicotine intake or quit cigarette smoking or vaping). Alternatively, a different communication protocol or technology, such as, for example, near field communication (NFC) or something else, may be used to communicate or transfer information between the device and a software application running on a mobile device, laptop, tablet, or desktop computer, or some other microprocessor based device.

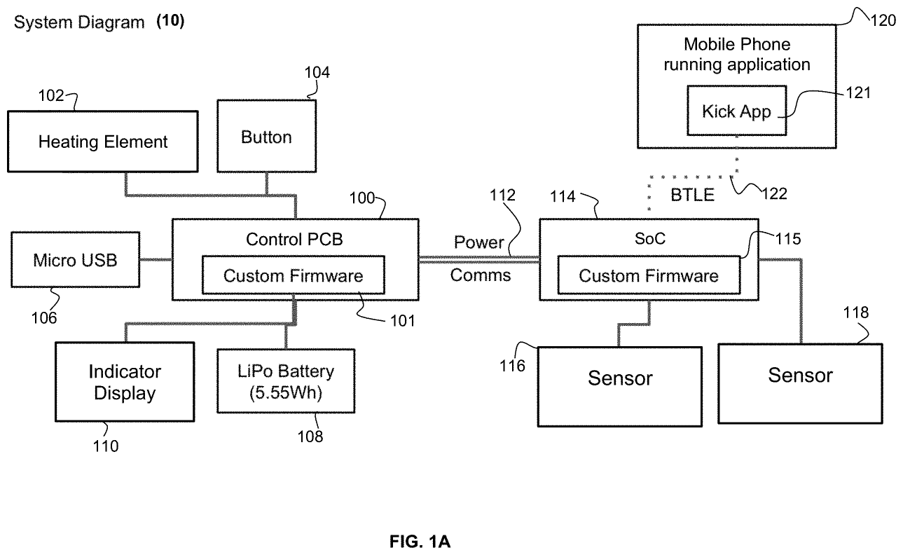

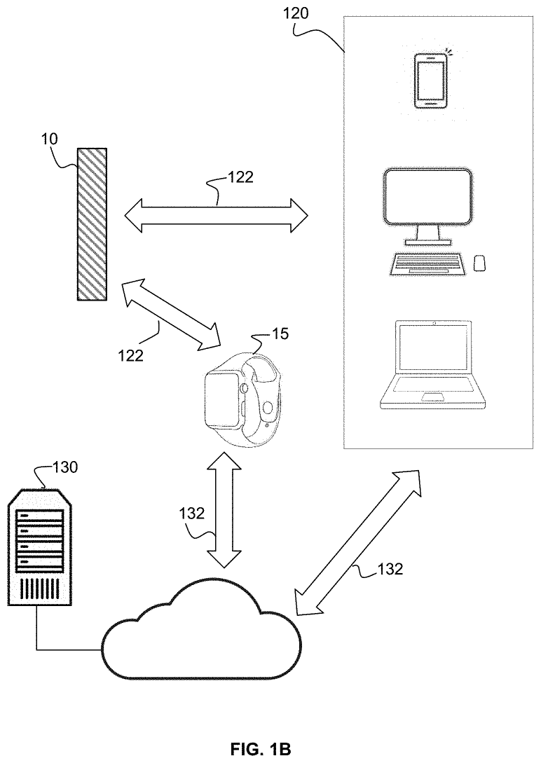

With reference to FIG. 1A, an exemplary system according to the present disclosure is schematically diagramed. The system 10 generally includes an electronic vaporizing device comprising a power source 108, a first sensor 116 configured to measure an ambient pressure, a second sensor 118 configured to measure an airflow within an air passage in the device, for example, by measuring a pressure, pressure differential, or pressure change, or by measuring air velocity, and a processor 100 in communication with the first and second sensors and the power supply, and a screen or display panel 110 such as an LCD, LED, OLED display, or some other display type.

The system may further comprise a button 104 in communication with the processor 100, wherein triggering the button may initiate the flow of power from the power supply 108 to a heating element 102 that may provide the energy required to vaporize a liquid, such as the liquid contained within a cartridge attached to the device. Additionally, or alternatively, the system may be activated, i.e., provide power from the power supply 108 to the heating element 102, by an inhalation from the user (e.g., inspiration at a threshold pressure), by a biometric authentication of the user (e.g., fingerprint scan), by a number or sequence of button depressions, or any combination thereof. For example, the system may require a biometric authentication to unlock and an inhalation from the user to activate the power supply to the heating element, or simply an inhalation from the user at a specific inspiration pressure, as measured by the sensors of the system. In some embodiments, the system may be activated by a measured resistance or capacitance level or change on or across the mouthpiece.

According to certain aspects, the heating element may be a coil or other heating element associated with the cartridge, wherein power is supplied to the coil through corresponding contacts on the device and the cartridge. According to certain other aspects, the heating element 102 may be a coil or other heating element associated with the device, wherein power may be supplied directly to the heating element 102 from the power supply 108 of the device.

With continued reference to FIG. 1, the device may further comprise a communication port 106 that may provide external power to the device and/or may charge the power supply 108. For example, when the power supply 108 comprises one or more rechargeable batteries, port 108 may be connected to an external power source (e.g., electrical outlet, another computing device, etc.). According to certain aspects, communication port 108 may also allow wired communication with an external processor, such as a computing device 120 of the user (i.e., mobile phone, table, laptop or desktop computer). An exemplary communication port 106 includes at least a USB such as, for example, a micro USB, mini-USB, USB-A, USB-C, or USB-C of either the USB 1.0-2.0 standard or the USB 3.0-3.1 standard. Alternatively, a lightning or thunderbolt connector or other type of connector may be used. The processor 100 of the device 10 may be programmed with instructions, i.e., custom firmware 101, for determining a flow rate of air across the heating element, or through an airflow pathway of the device, determining an amount of energy supplied to the heating element and a temperature of the heating element, and a dose of the vaporizable compound delivered to a user of the device in real time or in a single use session. Certain of this information may be displayed on the screen or display panel 110 (e.g., temperature of the heating element, device enabled or disabled, battery power, etc.).

The device may be configured for wireless communication 122, such as by inclusion of control circuitry (e.g., system-on-chip, SoC 114, having custom firmware 115) in communication 112 with the processor 100. An exemplary SoC includes the Nordic semiconductor nRF52840 multi-protocol system-on-chip, which is an ultra-low power blue tooth low energy enabled chip. This circuitry 114 may transmit readings from the sensors and/or calculations of the processor 100 wirelessly to a user's computing device, such as a user's mobile phone 120. As shown, the user may have a software application 121 installed on their mobile device 120 that may collect data from the device 10, may track use data for the device, may allow the user to input specific personal biometric data, may collect certain biometric data from one or more linked health monitor devices, and may configure user specific cessation programs and protocols based on that data and/or preprogrammed or other data.

In combination, the presently disclosed system allows a user to define a step-down or cessation timeline and protocol that will assist the user in nicotine and/or smoking cessation. As the user interacts with the presently disclosed device, i.e., smokes or vapes, the intake of the vaporized compound is measured in real time and compared to a predetermined compound limit for a predetermined time limit. Should the user reach that compound limit within the time limit, the device may disable further use thereof. As used herein, the terms “vaping” and “smoking” are interchangeable and may be understood to mean the intake of an aerosolized or vaporized liquid from an electronic vaporizing device. Moreover, while nicotine is discussed as the vaporizable compound in that liquid, other compounds may be monitored and the object of the presently disclosed cessation programs and protocols, such as the active ingredients and therapeutic compounds of any plant material or extract.

With specific reference to FIG. 1B, a schematic overview of the data transfer capability for the presently disclosed device and system is shown. As indicated, the device 10 may communicate wirelessly 122, such as, for example, through Bluetooth or Bluetooth low energy communication, to a user's computing device 120. The user's computing device may be any of a mobile phone or tablet, a laptop, and/or a desktop programmed to run certain algorithms of the present disclosure (i.e., app 121). The device 10 may further receive communication 122 from a user's heath monitor 15, such as, for example, a smart watch, oximeter, blood pressure monitor, pulse detector, or some other device, that may provide certain biometric values to the processor 100 and/or a memory of the device 10. Additionally, or alternatively, biometric information from the user's health monitor 15 may be gathered from a database housed on a server 130 via communication 132, for example, through the internet and/or the users computing device 120.

Certain information about the device 10 may be displayed by the device display 110, and/or may be sent to the user's computing device 120 and/or an external server 130. For example, software (e.g., an app) running on the user's computing device 120 may receive data from the device 10, for example, regarding a battery power status of the device, a wireless connectivity of the device, whether the device is enable or disabled, and usage information about the device during certain preset or user selected time periods.

Certain of the usage information may be presented to the user according to a variety of predefined and/or user selected display options (i.e., tables, graphs, charts, other formats) that may optionally be downloaded or exported, such as export of graphs or data to excel spreadsheets. Exemplary usage information may include at least graphs or tables of the use rate per use, hour, day, week, or month (i.e., number of puffs and/or timing of puffs); compound dose delivered per puff; cumulative compound dose per use, hour, day, week, or month; and/or current cessation program display as table or graph or calendar.

The user may interact with other device users, such as through a community platform that may be accessed through the app running on the user's computing device. Such a community platform may be part of the external server 130. Using the community platform, the user may be able to form a group with others who are quitting to send/receive messages of support and create positive peer pressure; add/remove people from a personal support group; view quitting progress of other users; and/or send and receive text messages to the other users.

Access to the device 10 and/or the app on the user's computing device 120 may be secure, wherein only a specific user may be enabled to use the device or access the software. For example, the device and/or app on the user's computing device may have security, such as, for example, biometric security which may require fingerprint, retinal, or facial recognition to access, or may be password secured.

Using the device, algorithms, software, and associated applications and hardware according to aspects of the present disclosure, the user may interact with the device and/or software to set and change intake limits of a vaporized compound, set a cessation timeline protocol, and adjust the cessation timeline and protocol based on feedback from the device and apps. For example, should the user desire to smoke more times during the predetermined time limit, but wish to maintain the originally designed cessation timeline, the protocol may be changed to provide a smaller quantity of the vaporized compound within each smoking use. Alternatively, the user may change the cessation timeline to extend the overall time to expected cessation.

According to aspects of the present disclosure, the amount of vaporized or aerosolized compound can be measured in real time using the sensors (116, 118) that measure inspiratory flow, i.e., the amount of air pulled through the device into the user's lungs. In certain embodiments, Inspiratory flow is calculated using a timed differential pressure measurement between atmosphere and a device airway near the user's mouth. A higher-pressure difference indicates higher inspiratory flow for any given liquid cartridge used with the device.

Cartridges usable in the presently disclosed device may comprise a range of designs and configurations for the airflow path and the airflow exit, i.e., the mouthpiece. Accordingly, the systems and algorithms of the present disclosure may be configured to account for such cartridge variations, such as through recognition of a cartridge type or user input of the cartridge type and use of a stored configuration profile for each cartridge type.

The cartridge configuration profiles may include calibration factors captured through benchtop calibration measurements of the various cartridge designs. In this way, the exact relationship between the sensor readings (i.e., measured differential pressure values) and an amount of airflow though the cartridge may be used to calculate the inspiratory flow. The configuration profiles for each cartridge type may also include information about a material of the heating element, e.g., heating coil, when the heating element is part of the cartridge, and the concentration of vaporizable compound in the material of the cartridge, e.g., the amount of nicotine in the liquid of the cartridge.

According to certain aspects, cartridges from different manufacturers may vary in design and configuration to an extent that the presently disclosed device may be configured to only accept a certain cartridge brand and/or configuration. For example, the type of contacts between the power supply of the device and the cartridge may vary, or the size of the cartridge may vary. In this case, the user may not need to input the brand or type of cartridge as an embodiment of the device may only work with a specific brand of cartridge. In some cases, however, the concentration of the vaporizable compound in the cartridge may vary, in which case such information may still be input (automatically or manually) to the device and/or system of the present disclosure (i.e., through user input or automatic recognition by the system of the cartridge information).

As disclosed herein, while the device, according to certain aspects, may be configured to accept only a certain brand and/or configuration of cartridge, the overall system components of the device disclosed herein would be unchanged. That is, the inclusion of certain sensors and the measurements garnered therefrom would remain consistent for various device embodiments.

In certain embodiments, in addition to inspiratory airflow, the presently disclosed device and system may measure and record in real time the energy delivered to the heating element, e.g., coil of the cartridge. This may be calculated by integrating the electrical power provided by the power supply of the device to the heating element over a specific time period, i.e., the amount of time the electric power is supplied. The electrical power measurement is derived by multiplying a measured voltage by the calculated current, wherein the current is derived from voltage measured across a sense resistor.

In certain embodiments, the temperature of the heating element may also be measured, such as by measuring the resistance of the heating element, e.g., coil, derived from the current and voltage applied to it, and using a stored correspondence value, such as a corresponding temperature stored in a memory, wherein the correspondence value may account for a material of the heating element.

Using the inspiratory flow and delivered energy calculated as described above, a concentration of the vaporizable compound delivered to the user may be calculated, such as at least about once every ten seconds, about once every 5 seconds, about once every 1 second, about once every 0.5 seconds, about once every 0.4 seconds, about once every 0.3 seconds, about once every 0.2 seconds, about once every 0.1 second, about once every 0.075 seconds, about once every 0.05 seconds, about once every 0.025 seconds, about once every 0.01 second, about once every millisecond, about once every micro second or more often or any time span in between, to provide use values in near real time. A simplified representation of the calculation used to determine a compound dosage is shown in EQ. 1:

Compound Dose=(Inspiratory Flow Rate)*(Compound Concentration)*(Electrical Power to Heating Element)*(Calibration)*Time EQN. 1

The calibration term in EQN. 1 above is calculated by running the device with each cartridge that it will be used with and measuring a weight of the vape liquid lost during a test run with known flow, compound concentration, power to the heating element, and time. This constant calibration data can also include the necessary information about the relationship between the measured pressure difference and the real air flow through the device (i.e., the calibration that relates the measured pressure differential and the inspiratory airflow discussed above).

The temperature of the heating element may also be used to limit the amount of power applied to the heating element. If it increases beyond a specified threshold which is included as part of the calibration data for a specific cartridge, the device may be configured to reduce the power applied. For example, in cartridges that use a wick to supply the compound containing material from the cartridge to the heating element (i.e., liquid to the coil), the power may be reduced so that the wick around the heating element does not burn.

According to certain aspects, the temperature of the heating element should remain roughly constant during a single use as rapid increases would indicate that there is not enough liquid in contact with the heating element. Such information may trigger an alert or warning, such as to the user that the cartridge installed in the device is low of liquid (i.e., alert presented on the display panel 110 of the device 10).

After each use of the device, e.g., each inhalation or puff from the device, a cumulative dosage consumed by the user in that predetermined time period may be calculated. Such calculations may be performed by the processor 100 of the device 10, by a processor on the user's computing device 120, and/or by a processor on the remote server 130 (see FIG. 1B). Every time the cumulative dosage is recalculated and/or conveyed to the device, the dosage limits (e.g., compound allowance for the specific day or date) associated with the user's quitting schedule may be re-evaluated. Many different algorithms can be applied to limit the user's vaporizable compound intake dosage, including:
(A) Disabling the device completely when the measured dosage reaches a total dosage limit or compound allowance;
(B) Leaving the device enabled but alerting the user that they have crossed their limit using notifications on the device 10 or on their computing device 120;
(C) Reducing the power delivered to the heating element each time the device is used past the limit so that less and less vaporized compound is delivered with each puff or each use session; and/or
(D) Reducing the time that the heating element is powered during each puff.

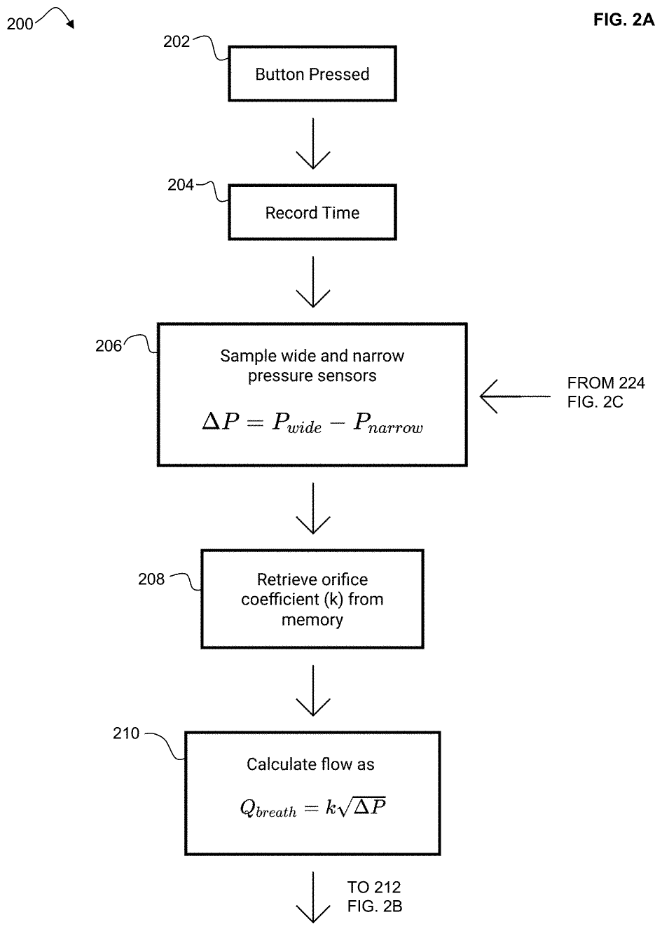

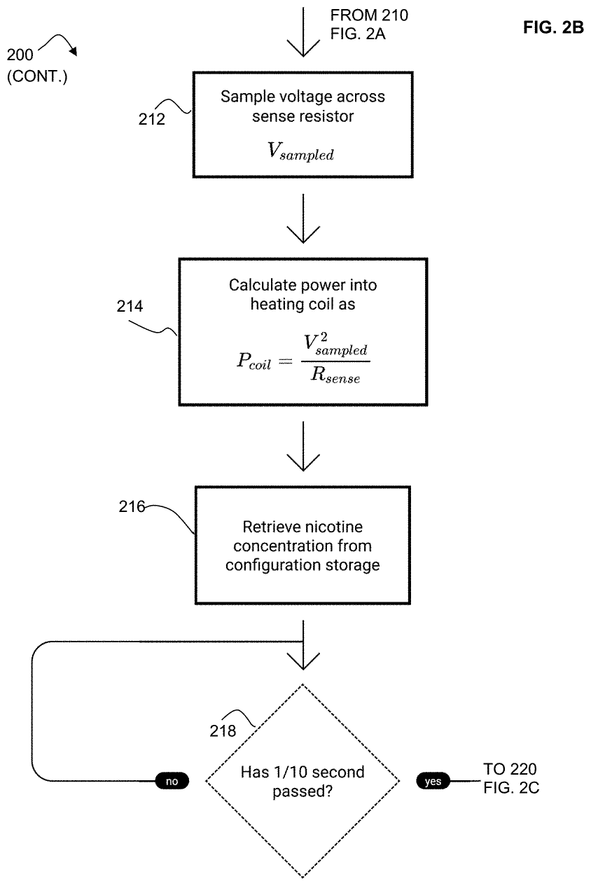

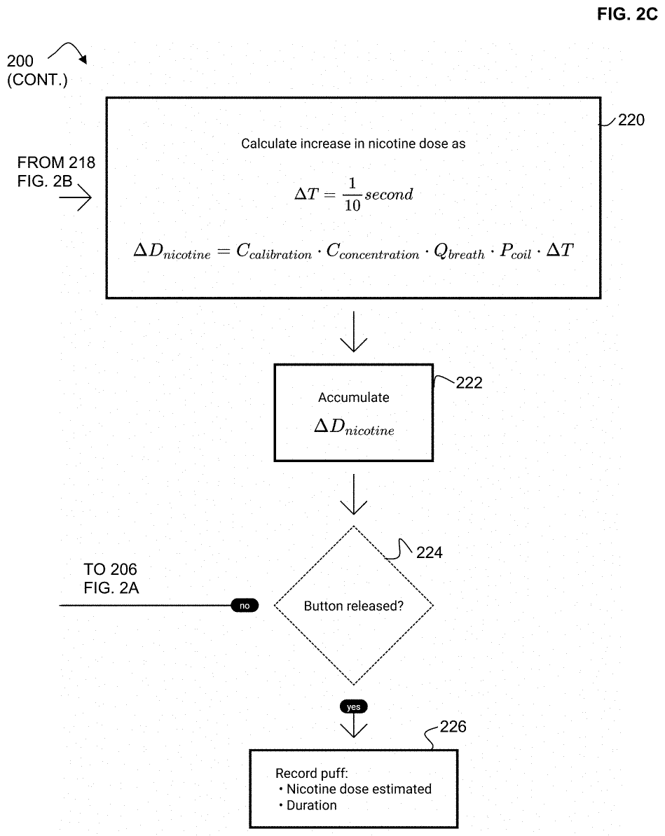

An exemplary algorithm 200 for limiting intake of a vaporizable compound according to certain aspects of the present disclosure is shown in the flow charts of FIGS. 2A-2C. With specific reference to FIG. 2A, a user may activate the device 10, such as by pressing a button, as shown in step 202, which may trigger power to be supplied to the heating element of the device from the power supply of the device, and may initiate a timer to start recording the time (record elapsed time from a timer and/or record the date and time, 204). As shown in step 206, pressure readings from each of a first and second pressure sensors may be recorded, and a differential pressure may be calculated. As described hereinabove, a cartridge or orifice coefficient (k) may be retrieved from a memory of the device, as in step 208, and an inspiratory airflow, Q_{breath}, may be calculated as a function of the pressure differential (ΔP) and the cartridge coefficient (k), as shown in step 210 and EQN. 2:

Q_{breath}=k\sqrt{ΔP} EQN. 2

With reference to FIG. 2B, a sample voltage across a sense resistor (Rₛₑₙₛₑ) may be recorded (V_{sampled}, 212), and that value may be used to calculate the power supplied to the heating element, as shown in step 214 and EQN. 3:

$${P}_{coil} = \frac{{V}_{sampled}^{2}}{{R}_{sense}} \qquad EQN . 3$$

A temperature of the heating element, as measured by the sense resistor, may also be recorded.

A concentration of the vaporizable compound in the cartridge (C_{concentration}) attached to the device may be stored in a memory of the device, i.e., as part of a cartridge configuration profile that was input or recorded by the user, and may be retrieved as indicated at step 216 to calculate a vaporizable compound inhaled by the user (step 220).

As noted in step 218, these readings, i.e., data received from the sensors and the calculated values of inspiratory airflow and power to the heating element (P_{coil}) may be made several times during a user inhalation, i.e., puff. For example, these readings and calculations may be made at least 2 times per second, such as at least 5 times per second, or even at least 10 times per second, or greater as discussed above. Accordingly, after each sensor reading and calculation, the system may calculate an elapsed time from when the timer started (e.g., button was pushed, inhalation threshold level exceeded, resistance or capacitance threshold level exceeded or change measured) or from when the last set of readings were made, and if the elapsed time is less than the desired time interval, the algorithm may wait to make any further measurements and calculations until that time interval has passed.

If the specified amount of time has passed, such as the exemplary 1/10 second indicated in step 218, the system may calculate a total vaporizable compound consumed by the user for that time interval, i.e., ΔD_{compound} wherein ΔT is the time interval (shown as 1/10 of a second in step 220 of FIG. 2C) using EQN. 4:

ΔT= 1/10 second

ΔD_{nicotine}=C_{calibration}·C_{concentration}*Q_{breath}·P_{coil}·ΔT EQN. 4

Recall that the C_{concentration} refers to the concentration of the vaporizable compound in the cartridge, and the C_{calibration} refers to the calibration coefficient that is unique to each cartridge, both of which may be stored in memory as part of the cartridge configuration profile. As indicated, this value may be calculated many times over the duration of a user inhalation, such as for the duration of the button trigger, wherein values calculated for each time interval may be accumulated to provide a cumulative vaporizable compound dose, as shown in step 222 (repeat entire process shown in steps 206-222 until button release 224 or pressed a second time or until a predetermined time period ends).

Once the button is released or repressed, such as at step 224, and power to the heating element is stopped, a total accumulated dose of the vaporizable compound may be calculated and recorded, as well as other characteristics of the use, such as duration of the inhalation or button trigger (226). This information may be stored in a memory of the device 10, and/or may be relayed, via the wireless communication 122 (see FIG. 1B), to a computing device of the user (120). According to aspects of the system, the total accumulated compound dose may be compared to compound allowances for a cessation program setup by the user and executed by processors on either or both of the device 10 and the user's computing device 120.

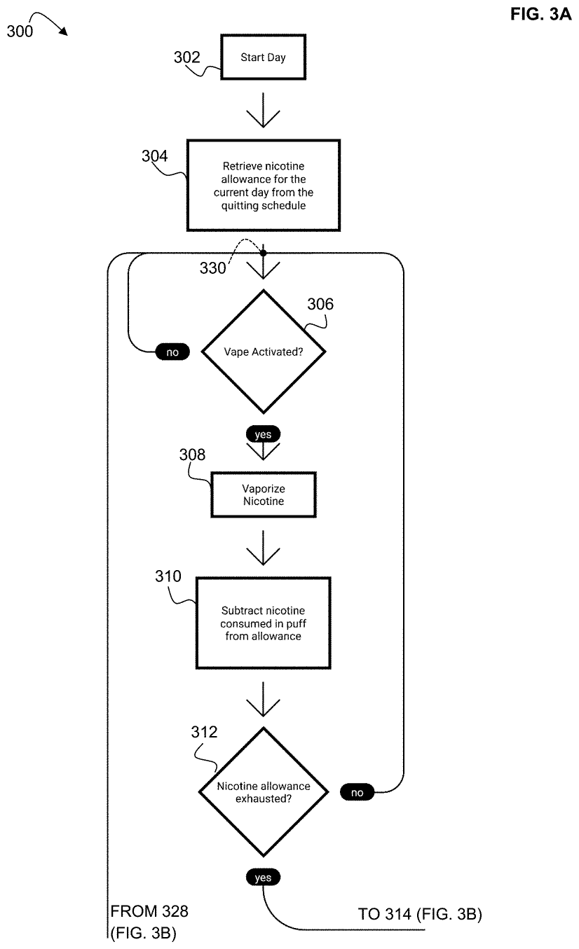

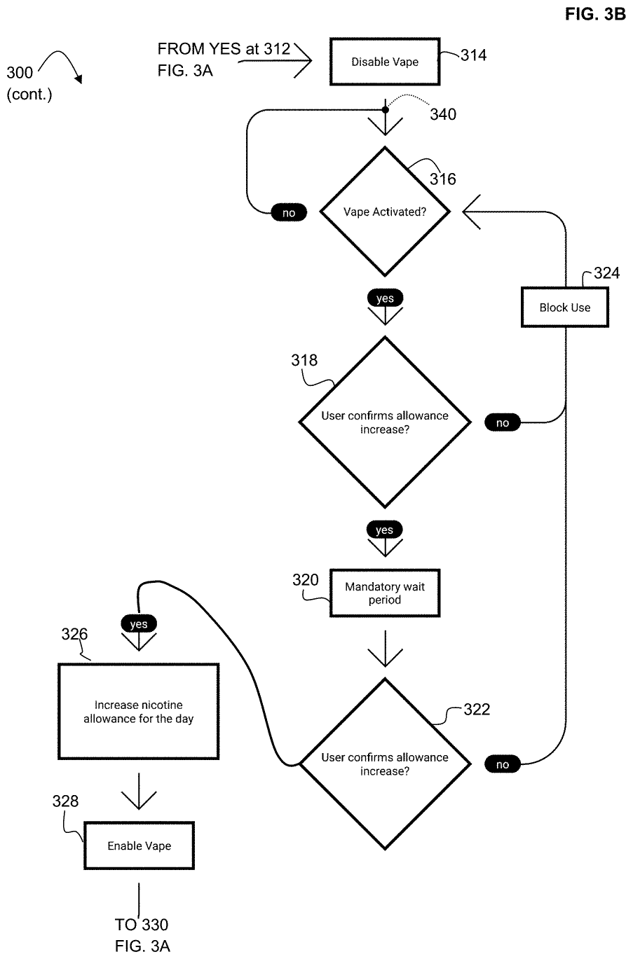

With reference to FIGS. 3A and 3B, shown is an exemplary flow chart depicting algorithms for nicotine cessation, i.e., reduction of vaporized compound consumption, according to aspects of the present disclosure. With specific reference to FIG. 3A, the cessation program may have a defined total compound dosage for a predetermined time period, such as a day, referred to as a compound allowance. Such data may be stored in a memory of the device 10, and additionally on a memory of the user's computing device 120 and/or on a memory of a server 130 with which the user's computing device 120 may interact via the internet 132.

At the start of the day 302, the algorithm may retrieve the total compound allowance for that current day from the quitting schedule 304 that is part of the cessation program. Upon activation of the device 10 by the user (306), such as by depressing the trigger button, the device may provide power to the heating element to vaporize the vaporizable material contained in a cartridge inserted in the device, as shown in step 308. A total amount of vaporizable compound consumed during one full activation of the device, i.e., during the full duration which the button is depressed, or between presses of the button, or during a predetermined time period, may be calculated as indicated in FIGS. 2A-2C, and may be subtracted from the compound allowance for the day, such as in step 310.

For each device activation, i.e., puff, the amount of vaporizable compound consumed may be accumulated, wherein a total accumulated amount may be compared to the compound allowance for the day, such as in step 312. Should the accumulated amount for that day remain below the allowance amount for the day, the user may be allowed to continue using the device 10, shown as a return to point 330 in FIG. 3A, wherein the algorithm waits for the next use of the device (step 306).

Should the accumulated amount for that day approach, equal, or exceed the compound allowance amount for the day at step 312, the system may disable the device 10 so that no more compound may be vaporized and consumed, as shown in step 314 of FIG. 3B. As used herein, “approach” of the accumulated amount to the compound allowance may be understood to be an amount that is below the compound allowance by less than a standard compound usage amount. The system may await a future use attempt by the user, such as shown in step 316, wherein several possible algorithms may be followed.

For example, upon another attempt to use the device (316), e.g., depressing the button to trigger vaporization of the compound, the device may remain disabled, i.e., return to 340, or may send a query to the user confirming that the user would like an increase in the compound allowance amount for that day, as shown in step 318. If the user wants to maintain their scheduled cessation program, no increase would be requested and the algorithm would continue to block use of the device (324) until the next predetermined time period begins, such as until the next morning.

If, however, the user choses to increase the compound allowance limit at step 318, the user may be required to wait a mandatory wait period, such as shown in step 320, after which the system may query the user regarding confirmation of the increased compound allowance limit, as shown in step 322. The user may elect to disregard the increased allowance limit and maintain the previously set cessation program, wherein the device will remain disabled (324) until the next predetermined time period begins, such as until the next morning.

Alternatively, the user may elect to increase the compound allowance, as shown in step 326, wherein the user may be allowed to resume use of the device, such as shown in step 328. The device would proceed with steps 306-312 until the newly set compound allowance limit was reached, whereupon the user may decide to maintain the new allowance setting and cessation program or may elect to set a new compound allowance limit.

As shown in FIGS. 3A-3B, the compound allowance is based on a specific predetermined time period, such as per day, and according to cessation programs of the presently disclosed system. With reference to FIG. 1B, the cessation programs may be setup through software downloaded onto the user's computing device 120 and/or through software stored on a server 130 accessed via the internet 132 by the user's computing device 120. During setup of the cessation program, the user may enter certain biometric data that may assist in defining the specific protocol that the user may follow. For example, the user may enter data such as any one or more of: a user age, weight, height, perceived fitness level, a perceived addiction level, a desired use rate of the device, previous use rates for electronic vaporizing devices or standard cigarettes, and gender. Certain of these data may also be received from a health monitoring device 15, e.g., Fitbit or Apple Watch, or other monitoring device, connected to the device 10 and/or to the user's computing device 120.

In addition to their biometric data, the user may input the brand and concentration of the cartridge that they will use with the device. As indicated above, this data may be obtained directly, such as by a scan of the cartridge by the user's computing device, or automatic recognition of the cartridge by the device. The user may also define a cessation time frame different than one predicted or defined by the algorithms of the software, and provide other data, such as geolocation data.

The cessation program may then be configured for that specific user, and compound limits per day, such as per specific calendar days, may be mapped and shared with the device 10. In general, the compound allowance dose may decrease based on some linear or polynomial function over a space of weeks or months, such that the compound allowance on any subsequent day would be lower than the compound allowance of a previous day. According to certain aspects, a dosing schedule of the cessation program may reduce the daily compound intake of the user over time to some lessor amount and/or to zero.

The dosing schedule of the cessation program may change the compound allowance amount based on a time of day and/or a day of the week. For example, a higher dose of the compound may be allowed in morning hours as compared to a dose allowed during the evening hours. This may be achieved by restricting use of the device during certain hours, such as increasing a wait time between allowable uses of the device. Alternatively, or additionally, a dose of the compound delivered by the device may be varied per use, such that a single use of the device may be configurable to provide different doses of the compound (e.g., uses in the morning hours may provide a higher compound dose). This latter option may be achieved by providing increased power to the heating element, within a specified allowable heat range for the cartridge, wherein the increased power will cause a greater amount of the liquid from the cartridge to be vaporized, and thus a larger amount of the compound to be provided to the user.

According to certain aspects, the dosing schedule of the cessation program may include intermittent fast periods, such as a period of hours or even a day where no compound delivery is allowed.

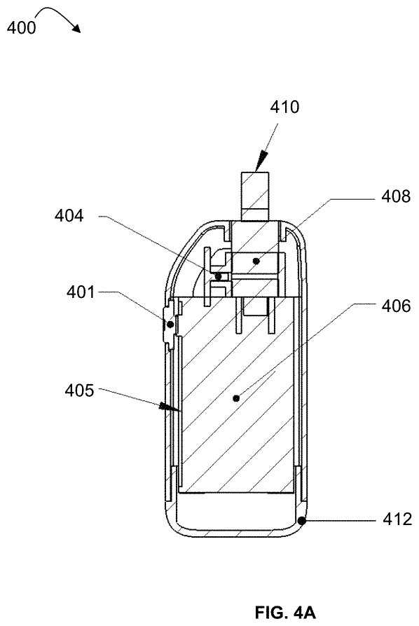

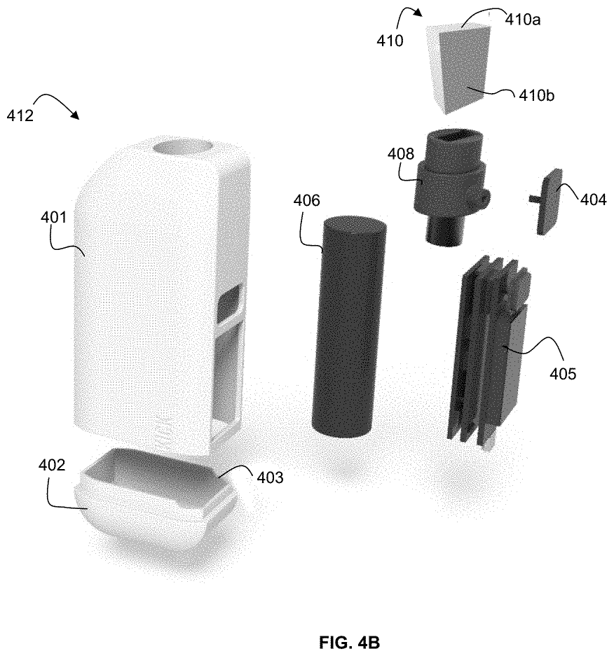

With reference to FIGS. 4A and 4B, an exemplary device 400 according to the present disclosure is shown as a housing 412 comprising two portions that encapsulates various components of the device, or in which various components of the device are housed. The housing 412 may include a top portion 401 connectable to a bottom portion 402 along a seam 403, wherein the top portion is secured over the seam 403 of the bottom portion 402. While shown in FIGS. 4A and 4B to have a specific shape, size, and means for accessing the battery and other internal components (i.e., top and bottom portions that separate), the housing 412 may be configured in a variety of shapes and sizes, and may include access doors, ports, windows, etc. to provide access to internal components. Alternatively, the housing 412 may be sealed in factory and may not provide the user with access to internal components.

Enclosed within the housing 412 of the device 400 are a power supply 406, such as a rechargeable lithium battery, a processor and display 405, such as an LCD screen that may convey information about the device or use limits of the device based on the cessation program (e.g., queries from the algorithm shown in FIG. 3A-3B may be displayed on the screen).

Also shown in FIGS. 4A and 4B are the cartridge 410 comprising a liquid tank 410b and a mouthpiece 410a. The cartridge 410 may fit within a holder or adapter 408 comprising one or more contacts configured for connection to one or more corresponding contacts on the cartridge, the contacts providing electrical connection between the power source of the device and the heating element of the cartridge 410. A sensor 404 may be positioned on the adapter 408 to measure an inhalation pressure (differential between atmospheric pressure and the pressure in an air flow path). While the heating element is described as being part of the cartridge 410, it may alternatively be configured to be a component of the device that is separate from the cartridge 410. In some embodiments, the sensor 404 may measure a capacitance level or change or resistance level or change on or across the mouthpiece of the cartridge 410.

The adapter 408 is configured to provide universal connection for a wide range of cartridges 410. That is, each adapter 408 may be designed to provide connection for a specific type and/or brand of cartridge 410. Different adapters 408 may be configured to accept various other sizes, shapes and/or brands of cartridges, thus providing a means for use a range of cartridges within the device 400 by simple exchange of the adapter 408 portion. According to certain aspects, the device 400 may be provided as part of a kit with one or more adapters that enable use of the device with several different cartridge sizes, shapes, and/or brands.

With specific reference to FIG. 4A, a button 401 is shown that may activate the supply of power from the battery 406 to the heating element. While shown and described herein as being activated by depressing a button, the presently disclosed system may additionally, or alternatively, be activated by an inhalation from the user (e.g., inspiration at a threshold pressure), by a biometric authentication of the user (e.g., fingerprint scan), by a number or sequence of button depressions, or any combination thereof.

While the cartridges indicated for use with the presently disclosed vaporizing device have been described as containing a liquid comprising a vaporizable compound, any of a large range of materials or combination of materials may be included in the cartridges. For example, the material may be a liquid, solid and/or gel formulation including, but not limited to, water, beads, solvents, active ingredients, ethanol, plant extracts, natural or artificial flavors, and/or vapor formers such as glycerin and propylene glycol.

The material may include nicotine or may exclude nicotine. The material may include one or more tobacco flavors. The material may include one or more flavors that are separate from one or more tobacco flavors.

Further, while the cartridge has been described as including a specific type of heating element, i.e., a resistive heater coil, various other types of heating elements are possible and within the scope of the present disclosure. For example, the heating element may be in the form of a wire coil, a planar body, a ceramic body, a single wire, a cage or mesh of resistive wire or any other suitable form, and the heating method may be any of conduction heating, convection heating, vibrational heating, or induction heating. Conduction heating occurs when material makes physical contact with the heating element having the compound containing material therein, convection heating may use a fan or the strength of the inspiratory flow to force heated air over the compound containing liquid or material, vibrational heating occurs when the wire is vibrated at a sufficiently high frequency such that the vibration causes an energy transfer to the material, and induction heating may provide heat to the material via wireless energy transfer.

Various embodiments of the present disclosure may be implemented in a data processing system suitable for storing and/or executing program code that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

According to certain aspects, each of these components may be provided on a system on a chip (SoC) and/or a printed circuit board (PCB) that are part of the device 10.

As described herein, a user's computing device 120 may include I/O devices (including, but not limited to, keyboards, displays, pointing devices, DASD, tape, CDs, DVDs, thumb drives and other memory media, etc.) that can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The present disclosure may be embodied in a system, a method, and/or a computer program product. The computer program product may include a computer readable storage medium (memory or media) having computer readable program instructions thereon for causing a processor to carry out aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, or code segments may be passed, forwarded, or transmitted via any suitable means including memory sharing, message passing, token passing, network transmission, among others.

The computer readable program instructions may execute entirely on the device and/or the user's computer, partly on the device and/or the user's computer, as a stand-alone software package, partly on the device and/or the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

Features or functionality described with respect to certain example embodiments may be combined and sub-combined in and/or with various other example embodiments. Also, different aspects and/or elements of example embodiments, as disclosed herein, may be combined and sub-combined in a similar manner as well. Further, some example embodiments, whether individually and/or collectively, may be components of a larger system, wherein other procedures may take precedence over and/or otherwise modify their application. Additionally, a number of steps may be required before, after, and/or concurrently with example embodiments, as disclosed herein. Note that any and/or all methods and/or processes, at least as disclosed herein, can be at least partially performed via at least one entity or actor in any manner.

The device and system of the present disclosure has been described with specific reference to certain drawings and various embodiments, but may, however, be embodied in many different forms and should not be construed as necessarily being limited to only embodiments disclosed herein. Rather, these embodiments are provided so that this disclosure is thorough and complete, and fully conveys various concepts of this disclosure to skilled artisans.

Note that various terminology used herein can imply direct or indirect, full or partial, temporary or permanent, action or inaction. For example, when an element is referred to as being “on,” “connected” or “coupled” to another element, then the element can be directly on, connected or coupled to the other element or intervening elements can be present, including indirect or direct variants. In contrast, when an element is referred to as being “directly connected” or “directly coupled” to another element, there are no intervening elements present.

Likewise, as used herein, a term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

Similarly, as used herein, various singular forms “a,” “an” and “the” are intended to include various plural forms as well, unless context clearly indicates otherwise. For example, a term “a” or “an” shall mean “one or more,” even though a phrase “one or more” is also used herein.

Moreover, terms “comprises,” “includes” or “comprising,” “including” when used in this specification, specify a presence of stated features, integers, steps, operations, elements, or components, but do not preclude a presence and/or addition of one or more other features, integers, steps, operations, elements, components, or groups thereof. Furthermore, when this disclosure states that something is “based on” something else, then such statement refers to a basis which may be based on one or more other things as well. In other words, unless expressly indicated otherwise, as used herein “based on” inclusively means “based at least in part on” or “based at least partially on.”

Additionally, although terms first, second, and others can be used herein to describe various elements, components, regions, layers, or sections, these elements, components, regions, layers, or sections should not necessarily be limited by such terms. Rather, these terms are used to distinguish one element, component, region, layer, or section from another element, component, region, layer, or section. As such, a first element, component, region, layer, or section discussed below could be termed a second element, component, region, layer, or section without departing from this disclosure.

Also, unless otherwise defined, all terms (including technical and scientific terms) used herein have the same meaning as commonly understood by one of ordinary skill in an art to which this disclosure belongs. As such, terms, such as those defined in commonly used dictionaries, should be interpreted as having a meaning that is consistent with their meaning in a context of a relevant art and should not be interpreted in an idealized or overly formal sense unless expressly so defined herein.

In addition, features described with respect to certain example embodiments may be combined in or with various other example embodiments in any permutational or combinatory manner. Different aspects or elements of example embodiments, as disclosed herein, may be combined in a similar manner. The term “combination”, “combinatory,” or “combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

Example Cessation Protocol

A user having a consumption of nicotine of 20 mg/day, e.g., consume one 5% nicotine pod every 2 days (40 mg nicotine per pod), equates to about 20 cigarettes per day (about 1 mg nicotine per cigarette). The system of the present disclosure may estimate the current nicotine dosage per inhalation (i.e., puff), and may apply a limit to the number of inhalations or the nicotine supplied per inhalation. For example, using a standard cartridge, the user may execute 100 puffs per day to consume the cartridge in 2 days (200 puffs for a standard cartridge comprising 40 mg nicotine). A conservative cessation protocol may comprise reducing the inhalations per day by 1, such that the user is now provided with 99 inhalations for the day. Thus, an exemplary cessation protocol may span 100 days, or about 3 months.

Additionally, or alternatively, the user may switch to cartridges having less nicotine, e.g., a 3% pod, during the course of the cessation protocol, and/or the system may alter the dose of nicotine provided per puff by reducing the power supplied to the heating element (e.g., lower heat on the heating element reduced the amount of nicotine aerosolized). Thus, a cessation protocol may comprise any combination of reduced number of inhalations per day and/or reduced dose of nicotine delivered per puff (e.g., lower nicotine cartridge and/or lower power to the heating element). Moreover, the user may eventually switch to cartridges absent nicotine, and may thus continue to vape or smoke without inhalation of nicotine. Note that while nicotine is provided in the above example, the cessation protocol would be the same for any other aerosolizable compound of interest.

Although preferred embodiments have been depicted and described in detail herein, skilled artisans know that various modifications, additions, substitutions and the like can be made without departing from spirit of this disclosure. As such, these are considered to be within the scope of the disclosure, as defined in the following claims.

1. A device, comprising:
a processor;
a heating element coupled to the processor;
an air flow sensor coupled to the processor;
an energy sensor coupled to the processor and the heating coil; and
a temperature sensor coupled to processor and the heating coil,
wherein the processor includes instructions that cause the processor to:
determine a flow rate of air across the heating element based on a signal from the air flow sensor,
determine an amount of energy delivered to the heating element based on a signal from the energy sensor,
determine a temperature of the heating element based on a signal received from the temperature sensor,
determine a baseline value for the device,
determine a dose of the compound during a predetermined period of time based on the flow rate, the amount of energy, the temperature, and the baseline value, and
set a parameter of the device to provide the determined dose.

2. The device of claim 1, wherein the air flow sensor is configured to determine inspiratory flow.

3. The device of claim 1, further comprising an airway and a mouthpiece, wherein the airway is near the mouthpiece, and wherein the flow rate of air across the heating element is determined based on a differential between an atmospheric pressure and a pressure at the airway.

4. The device of claim 1, wherein the energy sensor is configured to determine the amount of energy delivered to the heating coil.

5. The device of claim 1, wherein the energy sensor comprises a voltage meter.

6. The device of claim 1, wherein the amount of energy is determined by multiplying a measured voltage across a resistor at the heating element by a determined current at the heating coil.

7. The device of claim 1, wherein the temperature sensor is configured to sense the temperature of the heating coil.

8. The device of claim 1, wherein the temperature of the heating element is determined by measuring the voltage and current applied to the heating element and based on a heating element material.

9. The device of claim 1, wherein the baseline value is determined based on an amount of a compound used during a predetermined period of time at a predetermined air flow rate, a predetermined compound concentration, and a predetermined heating element power.

10. The device of claim 1, wherein the dose of the compound is determined based on the determined flow rate, the predetermined compound concentration, the determined element power, the baseline value, and a time period during which the device is used.

11. The device of claim 1, wherein the dose is determined based on a plurality of determinations over the predetermined period of time.

12. The device of claim 11, wherein the determinations are made at a rate exceeding 10 cycles per second.

13. The device of claim 1, wherein the baseline value is determined based on at least one of a user trial, user utilization, or testing.

14. The device of claim 1, wherein at least one of the dose or the parameter is determined based on a biometric feedback of the user.

15. The device of claim 1, wherein at least one of the dose or the parameter is determined in real time.

16. The device of claim 1, wherein at least one of the dose or the parameter is adjusted continually.

17. The device of claim 1, wherein at least one of the dose or the parameter is determined at least one of prior to or after each inhalation from the device.

18. The device of claim 14, wherein at least one of the dose or the parameter is determined at least one of prior to or after each inhalation from the device.

19. The device of claim 1, further comprising determining a weaning schedule based on at least one of the dose of the compound during the predetermined period of time or the parameter.

20. The device of claim 19, wherein the weaning schedule is static.

21. The device of claim 19, wherein the weaning schedule is dynamic.

22. The device of claim 21, wherein the weaning schedule is updated in real time

23. The device of claim 1, further comprising determining a deviation from a weaning schedule based on at least one of the dose of the compound during the predetermined period of time or the parameter.

24. The device of claim 23, further comprising determining a new weaning schedule based on the deviation.

25. The device of claim 23, wherein at least one of the dose or the parameter is adjusted based on the deviation.

26. A method for providing a determined dose of a vaporizable compound from a device having a processor, a heating element coupled to the processor, an air flow sensor coupled to the processor, an energy sensor coupled to the processor and the heating coil, and a temperature sensor coupled to the processor and the heating coil, wherein the processor includes instructions for:
determining, via the processor, a flow rate of air across the heating element of the device based on a signal from the air flow sensor in the device;
determining, via the processor, an amount of energy delivered to the heating element based on a signal from the energy sensor in the device;
determining, via the processor, a temperature of the heating element based on a signal received from the temperature sensor in the device;
determining, via the processor, a baseline value for the device;
determining, via the processor, a dose of the compound during a predetermined period of time based on the flow rate, the amount of energy, the temperature, and the baseline value; and
setting, via the processor, a parameter of the device to provide the determined dose.

27. A controlled delivery system for a vaporizable compound, the system including an electronic vaporizing apparatus configured to accept a liquid containing cartridge, wherein the apparatus comprises:
an air inlet connected to a flow path,
a vaporizer comprising a heating element and a power source, the vaporizer configured to heat a liquid received from the liquid containing cartridge and air received from the flow path to produce a vaporized liquid,
a first pressure sensor configured to measure an ambient pressure,
a second pressure sensor configured to measure a pressure of the air received from the flow path,
a control circuitry connected to the first and second pressure sensors, the vaporizer, and a timer,
a memory storing a total compound limit for a predetermined time period, and
a processor programmed to collect measurements including a temperature of the heating element, an energy delivered to the heating element, the pressure of the air received from the flow path, and a length of time the air in the flow path has a pressure greater than the ambient pressure, and to calculate a measured compound dose and a cumulative compound dose,
wherein the cumulative compound dose is cumulative of the measured compound dose for the predetermined time period, and
wherein if the cumulative compound dose is equal to or greater than the total compound limit, the control circuitry stops power supply to the heating element.
